(19) United States
(12) Patent Application Publication
(10) Pub. No.: US 2026/0261108 A1
(43) Pub. Date: Sep. 3, 2026

(54) CABLE HANGER AND RETENTION ARRANGEMENTS THEREFOR

(71) Applicant: Cambria County Association for the Blind & Handicapped, Johnstown, PA (US)

(72) Inventors: JASON RICHARD MARTINAGE, South Fork, PA (US); KRISTOFER RUMMEL, Ebensburg, PA (US)

(73) Assignee: Cambria County Association for the Blind & Handicapped, Johnstown, PA (US)

(21) Appl. No.: 19/552,192

(22) Filed: Feb. 27, 2026

Related U.S. Application Data
(60) Provisional application No. 63/764,958, filed on Feb. 28, 2025.

(51) Int. Cl. H02G 7/06

(52) U.S. Cl. CPC H02G 7/06

(57) ABSTRACT

A cable hanger for supporting a plurality of electrical cables along a messenger wire in a solar power installation. The cable hanger includes a number of cable support structures and a retention arrangement coupled to the number of cable support structures for coupling the cable hanger to the messenger wire. The retention arrangement includes a hook portion extending from the number of cable support structures that loops over the messenger wire in a reference plane perpendicular to the messenger wire and extends outward from a central vertical axis of the hanger to a bend. A locking portion extends from the bend at a first angle relative to the reference plane and a second angle relative to a plane disposed perpendicular to the central vertical axis. When installed on the messenger wire, the locking portion extend under and protrudes beyond the messenger wire.

### CROSS REFERENCE TO RELATED APPLICATIONS

This application claims priority to U.S. Provisional Patent Application Serial No. 63/764,958, filed on February 28, 2025, titled “CABLE HANGER AND RETENTION ARRANGEMENTS THEREFOR” the disclosure of which is incorporated herein by reference.

### FIELD

The disclosed concept relates generally to cable hangers for supporting cables. More particularly, the disclosed concept relates to cable hangers for hanging on a messenger wire and supporting cables strung along generally the same route as the messenger wire. Even more particularly, the disclosed concept relates to retention arrangements for preventing cable hangers from being dislodged from messenger wires.

### BACKGROUND

There are many environments/situations in which cables, such as those used to convey electrical current, need to be strung in an organized manner. For example, in large-scale solar power generating plants/arrangements, various quantities of cables (e.g., without limitation, DC power cables, commonly in pairs) are commonly utilized to convey electrical current generated by solar panels from the solar panels to production and/or transmission equipment within the plant. Other cables conveying current and/or signal data to/from various equipment are also commonly utilized. U.S. Patent Nos. 10,177,551 and 10,978,861 (which are commonly assigned with the present matter), the contents of which are incorporated by reference herein, describe some above-ground arrangements that have been utilized to organize cables used in solar power plants.

As the use of solar panels has grown, so too has the variety of environments in which they are installed. For example, in some installations solar panels, and thus the accompanying cabling, are installed in fields and similar locations where animals such as cows, sheep, goats, etc., graze among the installation. In such instances, such animals may commonly contact and rub against structures supporting the solar panels as well as cabling arrangements organized below and/or adjacent to the panels. Such interactions with animals can cause hangers to be dislodged from the messenger wire of conventional systems (as well as cables to be dislodged from hangers) which can lead to failures of one or more components of the system and/or lead to safety issues (e.g., shorting of the wiring, fires, etc.). Thus, a need exists for improved arrangements for securing cable hangers to messenger wires for use in such situations. Embodiments of the concept disclosed herein address such needs among numerous benefits.

### SUMMARY

Embodiments of the disclosed concept improve upon conventional cable hangers used in separating and supporting electrical cables, such as DC power cables, used in solar power installations. In one example embodiment, a cable hanger for supporting a plurality of electrical cables along a messenger wire in a solar power installation is provided. The cable hanger comprises: a number of cable support structures sized and configured to be disposed below the messenger wire when the cable hanger is positioned on the messenger wire; and a retention arrangement coupled to the number of cable support structures and structured to couple the cable hanger to the messenger wire, the retention arrangement comprises: a hook portion extending from the number of cable support structures and structured to loop back over the messenger wire in a reference plane perpendicular to the messenger wire and extend outward from a central vertical axis of the hanger to a bend; and a locking portion extending from the bend at a first angle relative to the reference plane and a second angle relative to a plane disposed perpendicular to the central vertical axis, wherein the locking portion is structured to extend under and protrude beyond the messenger wire when the cable hanger is installed on the messenger wire.

The first angle may be in the range of about thirty to thirty five degrees. The second angle may be in the range of about negative ten to plus ten degrees. The second angle may be in the range of about negative ten to plus ten degrees.

The locking portion may be structured to be in engagement with the messenger wire when the hanger is installed on the messenger wire.

The hook portion may define an eye that is structured to fit snugly around the messenger wire.

The retention arrangement may be formed from a shape retention wire. The shape retention wire may comprise a PVC coating disposed thereon.

The number of support structures may comprise a plurality of upwardly opening cable support receptacles, each cable support receptacle structured to support at least one electrical cable of the plurality of electrical cables. The number of upwardly opening cable support receptacles may comprise a plurality of upwardly opening receptacles.

The number of support structures and the retention arrangement may be portions of a single shape retention wire. The shape retention wire may include a coating disposed thereon. The shape retention wire may be encased in the coating.

The cable hanger may comprise a shape retention wire; the number of support structures may comprise a plurality of upwardly opening receptacles, each structured to receive a number of cables of the plurality of electrical cables; each receptacle of the plurality of receptacles may include a trough area and lateral sides extending upwardly from the trough area; at a top of the outer lateral side of each of the outermost receptacles may be a bend that joins the lateral side with a support arm that extends toward a central vertical axis of the cable hanger; the hook portion of the retention arrangement may be disposed at an end of the support arm; and the plurality of receptacles, the bend at the top of the outer lateral side of each of the outermost receptacles and the support arm that extends toward the central vertical axis, and the retention arrangement may each be portions of the shape retention wire. The shape retention wire may be encased in a coating.

Such improvements and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the disclosed concept.

### BRIEF DESCRIPTION OF THE DRAWINGS

A full understanding of the disclosed concept can be gained from the following description of the preferred embodiments when read in conjunction with the accompanying drawings in which:

FIG. 1 is an elevation view of a cable hanger having a retention arrangement in accordance with an example embodiment of the disclosed concept shown fully coupled to an exemplary portion of a messenger wire;

FIG. 2 is a detail perspective view of a portion of the cable hanger of FIG. 1 showing details of the retention arrangement coupling the hanger to the portion of the messenger wire;

FIG. 3 is another detail perspective view a portion of the cable hanger of FIG. 1 showing details of the retention arrangement coupling to the hanger to the portion of the messenger wire;

FIG. 4 is an elevation view of a cable hanger having a retention arrangement in accordance with another example embodiment of the disclosed concept shown fully coupled to an exemplary portion of a messenger wire;

FIG. 5 is a detail perspective view of a portion of the cable hanger of FIG. 4 showing details of the retention arrangement coupling the hanger to the portion of the messenger wire;

FIG. 6 is another detail perspective view of the cable hanger of FIG. 4, with the hanger only partially coupled to the portion of the messenger wire by the retention arrangement, showing details of the retention arrangement;

FIG. 7 is another detail perspective view similar to that of FIG. 6 with the hanger only partially coupled to the portion of the messenger wire by the retention arrangement showing details of the retention arrangement;

FIG. 8, similar to FIG. 5, is a detail perspective view of a portion of the cable hanger of FIG. 4 showing details of the retention arrangement coupling the hanger to the portion of the messenger wire;

FIG. 9 is an elevation view of a cable hanger having a retention arrangement in accordance with yet another example embodiment of the disclosed concept shown fully coupled to an exemplary portion of a messenger wire;

FIG. 10 is a detail perspective view of a portion of the cable hanger of FIG. 9, with the hanger only partially coupled to the portion of the messenger wire by the retention arrangement, showing details of the retention arrangement;

FIG. 11 is another detail perspective view showing a similar portion to that of FIG. 10, with the hanger only partially coupled to the portion of the messenger wire by the retention arrangement, showing details of the retention arrangement;

FIG. 12 is yet another detail perspective view showing a similar portion to those of FIGS. 10 and 11, with the hanger only partially coupled to the portion of the messenger wire by the retention arrangement, showing details of the retention arrangement;

FIG. 13 is a detail perspective view of a portion of the arrangement of FIG. 9 showing details of the retention arrangement coupling the hanger to the portion of the messenger wire;

FIG. 14 is a top view of the arrangement of FIG. 9 showing details of the retention arrangement coupling the hanger to the portion of the messenger wire as well as a plurality of example cables shown disposed on/in the hanger;

FIG. 15 is a perspective view of a cable hanger in accordance with a further example embodiment of the disclosed concept having a retention arrangement similar to that shown in FIGS. 9-14 shown fully coupled to an exemplary portion of a messenger wire;

FIGS. 16-18 are further perspective views of the cable hanger and portion of the messenger wire shown in FIG. 15;

FIGS. 19 and 20 are elevation views of the cable hanger and portion of the messenger wire shown in FIGS. 15-18; and

FIG. 21 is a top view of the cable hanger and portion of the messenger wire of FIGS. 15-20.

### DETAILED DESCRIPTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, and as used herein, “structured to [verb]” recites structure and not function. Further, as used herein, “structured to [verb]” means that the identified element or assembly is intended to, and is particularly designed to, perform the identified verb. Thus, an element that is merely capable of performing the identified verb but which is not intended to, and is not designed to, perform the identified verb is not “structured to [verb].”

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the term “number” shall mean one or an integer greater than one (i.e., a plurality). Thus, for example, a “number of elements” means one element or a plurality of elements.

As used herein, the term “about” when used in conjunction with an angular measurement shall mean the stated angular amount and angular amounts within three degrees thereof.

Embodiments of the disclosed concept provide solutions for supporting and separating electrical cables, e.g., DC power cables, associated with solar panel installations which are resistant to potential detrimental effects from encounters with animals and other objects.

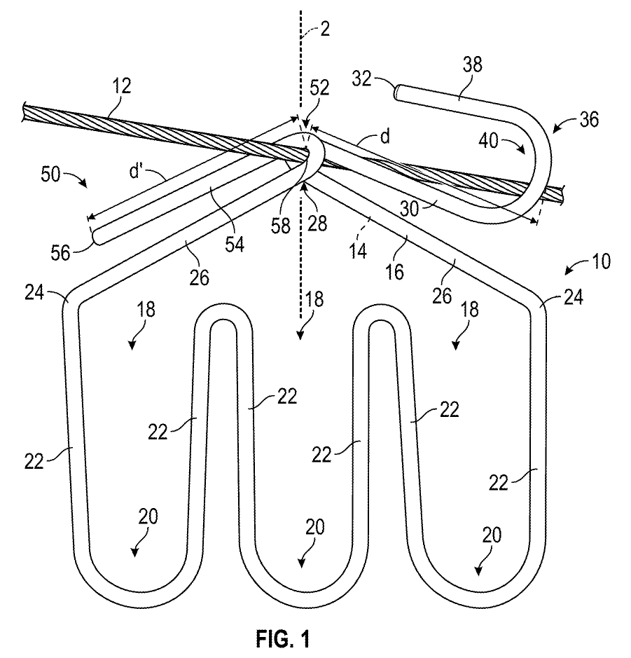

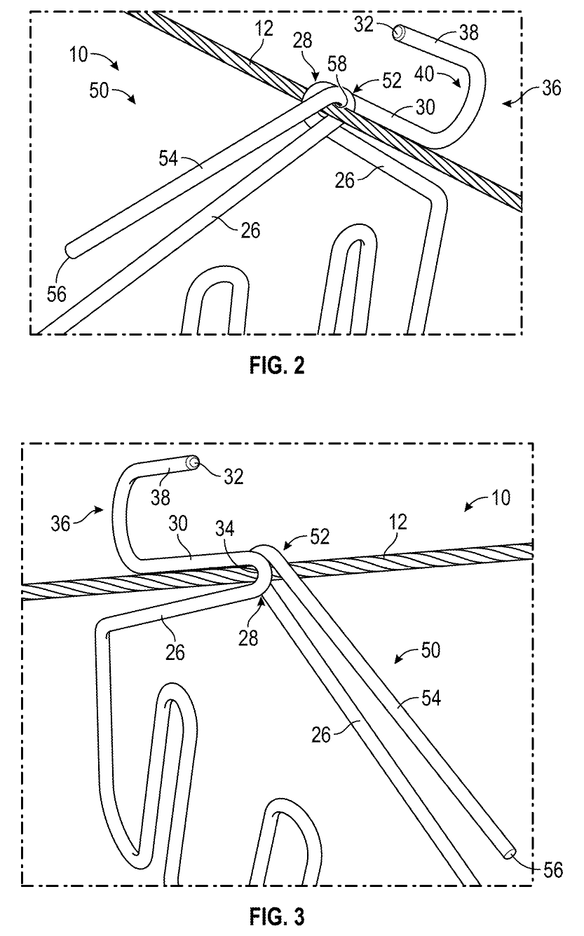

A cable hanger 10 in accordance with an example embodiment of the disclosed concept shown selectively coupled with an example portion of a messenger wire 12 is shown in FIGS. 1-3. In such example, cable hanger 10 is of similar construction as those such as described in U.S. Patent No. 9,800,028 (which is commonly assigned with the present matter) except, most notably, hangers in accordance with example embodiments of the disclosed concept include one or more retention arrangements which provide further resistance to such hangers from being accidentally uncoupled from the messenger wire 12, as described further below. Accordingly, it is to be appreciated that such hangers in accordance with the disclosed concept may generally be installed on a messenger wire in a similar manner (albeit perhaps a bit more difficult depending on the embodiment) as discussed in the aforementioned patent and thus a general detailed description of such operation is not provided herein.

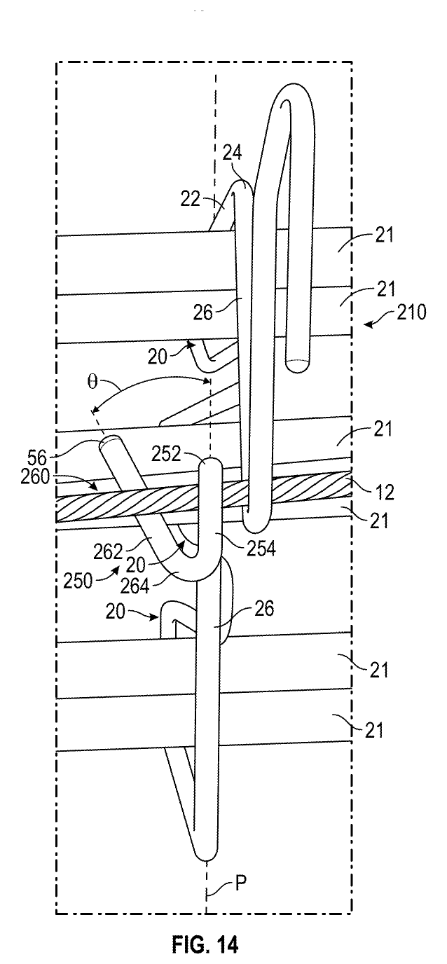

Referring to FIGS. 1-3, the cable hanger 10 is comprised of a shape retention wire 14 that is covered by an (optional) coating 16 adhered thereto (e.g., a PVC or other suitable coating, such as described in the aforementioned patent). In some example embodiments, the shape retention wire is completely encased in the coating 16. The cable hanger 10 has a number of upwardly opening cable support receptacles 18 (three are shown in such example), each structured to receive a number, typically a plurality, of cables 21 (e.g., see FIG. 14 described further below) provided therein. Each receptacle 18 includes a trough area shown generally at 20. Lateral sides 22 extend upwardly from each trough area 20 to form each upwardly opening receptacle 18. At the top of the outer lateral side 22 of each of the outermost receptacles 18 is a bend 24 that joins the lateral side 22 with a support arm 26 that extends towards a central vertical axis 2 (FIG. 1) of the hanger 10. At the central innermost end of one of the support arms 26 is a hook 28 formed by a first portion 30 of the wire 14, spaced from a first tip 32 of the wire 14, that is bent back along a line substantially parallel to the centerline of the aforementioned support arm 26. As used herein, substantially parallel means within 5 degrees or less of being parallel. An eye 34 (FIG. 3) is defined by the hook 28. In example embodiments the eye 34 is sized (accounting for the coating 16 in some examples) so as to fit snugly around a support wire (e.g., messenger wire 12). The first portion 30 of the wire 14 extends outwardly from the center of the hanger 10 (i.e., outwardly from the hook 28) until it forms a loop 36 by bending the first tip 32 of the wire 14 along with a second portion 38 of the wire adjacent the tip 32 back so that tip 32 points toward the central vertical axis 2 of the hanger 10. The loop 36 has an eye 40 that will act, in at least one example embodiment as a support for a signal wire or wires (not shown), and in other embodiments may be used to support other cabling (e.g., signal, power, etc.). The eye 40 is loose fitting which allows the signal wire to be slipped in and out of the eye 40 generally without interference. In some example embodiments in accordance with the disclosed concept, the hook 28 has a depth d (FIG. 1) of about 5.25 +/- .75 inches.

Continuing to refer to FIGS. 1-3, the hanger 10 further includes a retention arrangement 50 for further securing the hanger 10 to a support wire (e.g., messenger wire 12) in a manner such that the installed hanger 10 will not be unwantingly dislodged from the support wire 12 by an animal or other object. In such example embodiment the retention arrangement 50 includes a hook 52 is formed by bending a third portion 54 of the shape retention wire 14, that is adjacent a second tip 56 of the wire 14 opposite the first tip 32, backwards along a line substantially parallel to the adjacent support arm 26. In this way, an eye 58 is formed that has similar dimensions to eye 34 and the third portion 54 overhangs the portion of the hanger 10 below such that the hook 52 has a depth d’ (FIG. 1). In some example embodiments of the present concept, the depth d’ of the hook 52 is 5.25 +/- .75 inches so as to prevent the support wire from being dislodged from the hook 58 by an animal or other object engaging the hanger 10, and thus preventing the hanger 10 and/or cables supported therein/thereby from becoming uninstalled (in-whole or in-part) from the support wire when engaged by an animal or other object.

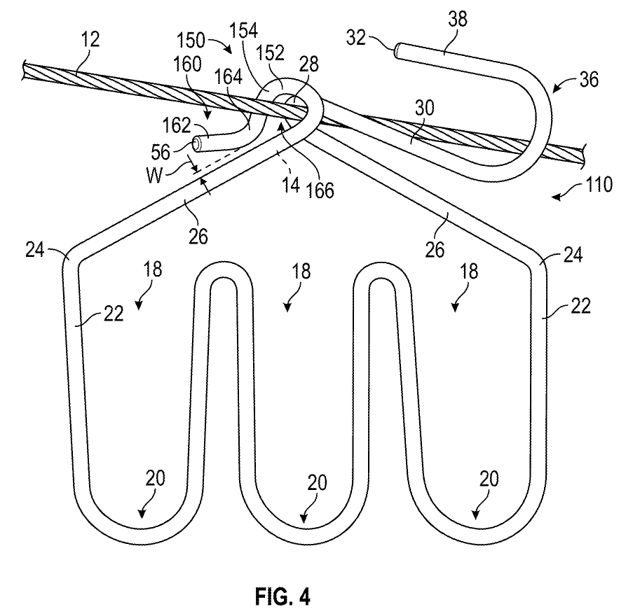

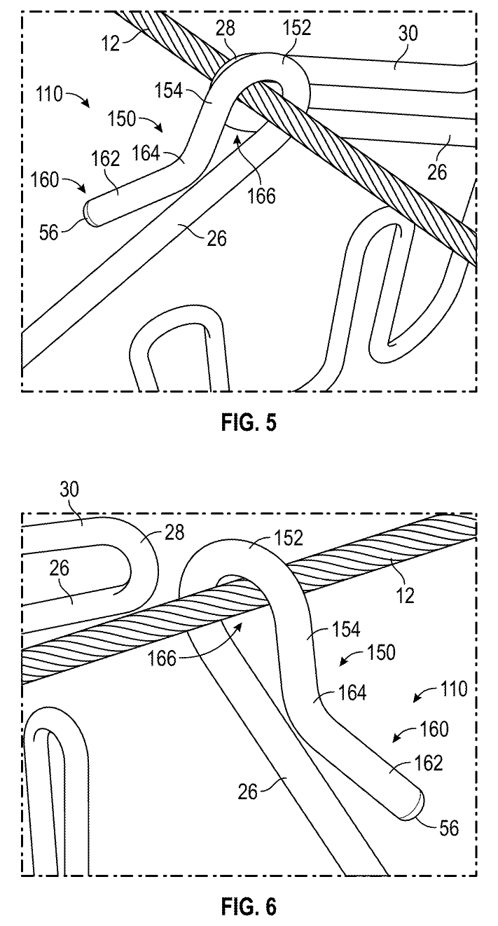

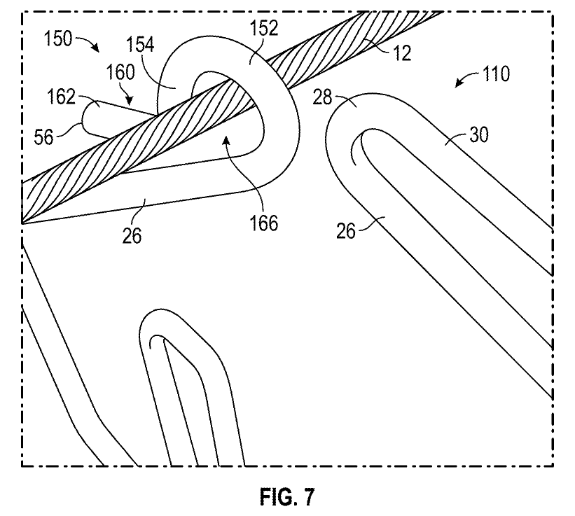

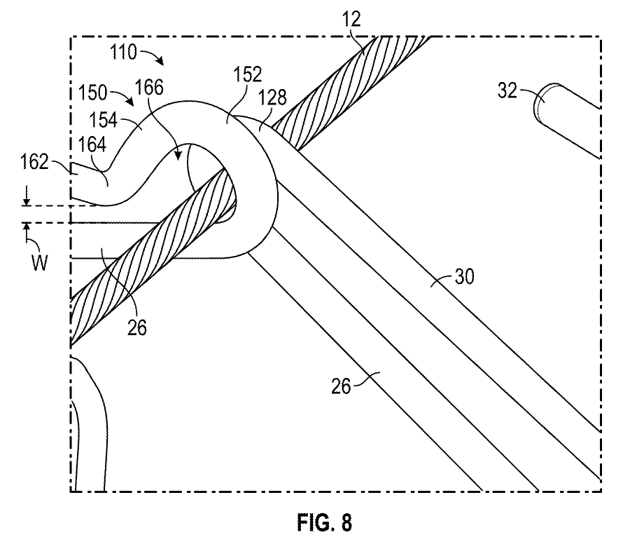

Another example cable hanger 110, similar to cable hanger 10 but having a retention arrangement 150 in accordance with another example embodiment of the disclosed concept, is shown in FIGS. 4-8 along with an example portion of the messenger wire 12. In such example, the retention arrangement 150 incudes a loop 152 formed by bending a third portion 154 of the wire 14, spaced from the second tip 56, outward from a central vertical axis (e.g., see axis 2 of FIG. 1) of the hanger 110 and above the adjacent support arm 26 more than 180 degrees with respect to the adjacent support arm 26 such that the third portion 154 is angled back down toward the adjacent support arm 26. The retention arrangement 150 further includes a lead in portion 160 extending from the third portion 154 that is formed by bending the tip 56 and a fourth portion 162, adjacent the tip 56 and the third portion 154, upward away from the adjacent support arm 26. Accordingly, the third portion 154 and the fourth portion 162 are separated by a bend 164 that is spaced from the adjacent support arm 26 by a width w (FIG. 4) which is smaller than the diameter (not labeled) of the messenger wire 12. In an example embodiment of the disclosed concept the width w is about 0.22 inches, although other widths may be employed depending on the diameter of the messenger wire 12 without varying from the scope of the disclosed concept. The loop 152 has an eye 166 that is sized to very loosely fit around the messenger wire 12 after the messenger wire 12 has been generally “snapped” between the bend 164 and the adjacent support arm 26. In some example embodiments the eye is about 0.5 inches in diameter, although other sizing may be employed depending on the diameter of the messenger wire 12 without varying from the scope of the disclosed concept. The loose fit of the loop 152 along with the snap fitting of the messenger wire 12 to position the messenger wire therein serve to retain the messenger wire 12 within the loop 152 if/when the hanger 110 is engaged by an animal or other object, thus preventing the hanger 110 from becoming dislodged from the messenger wire.

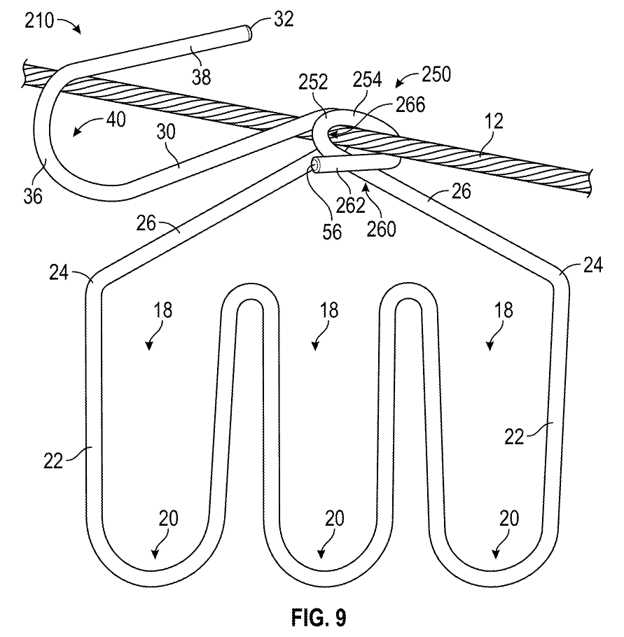

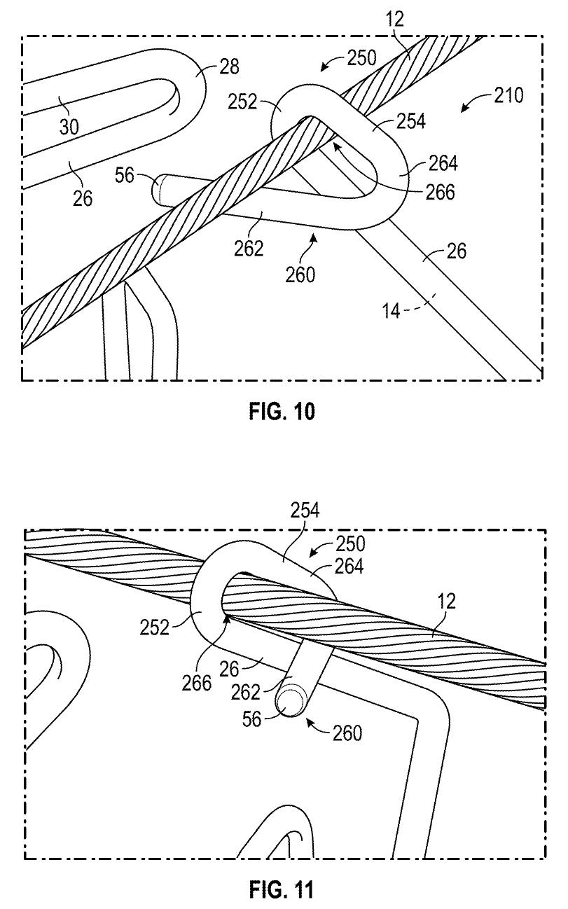

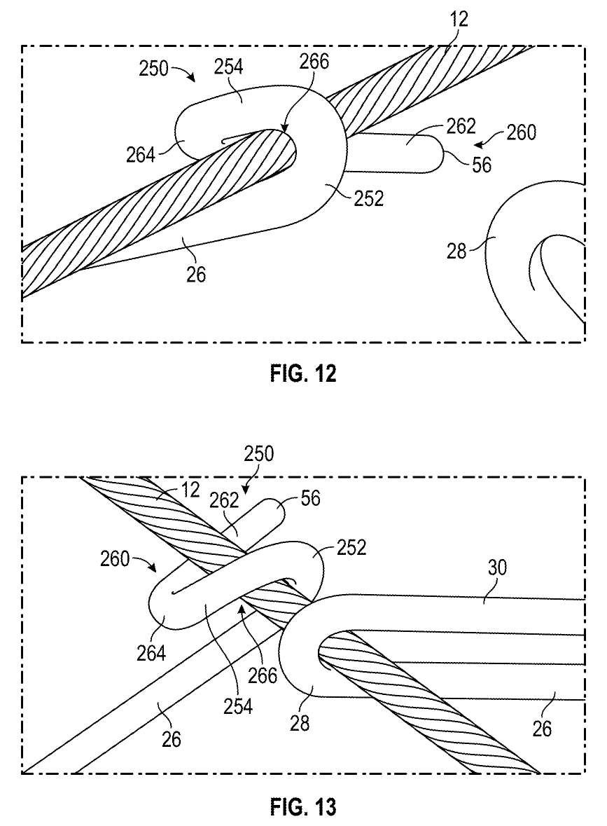

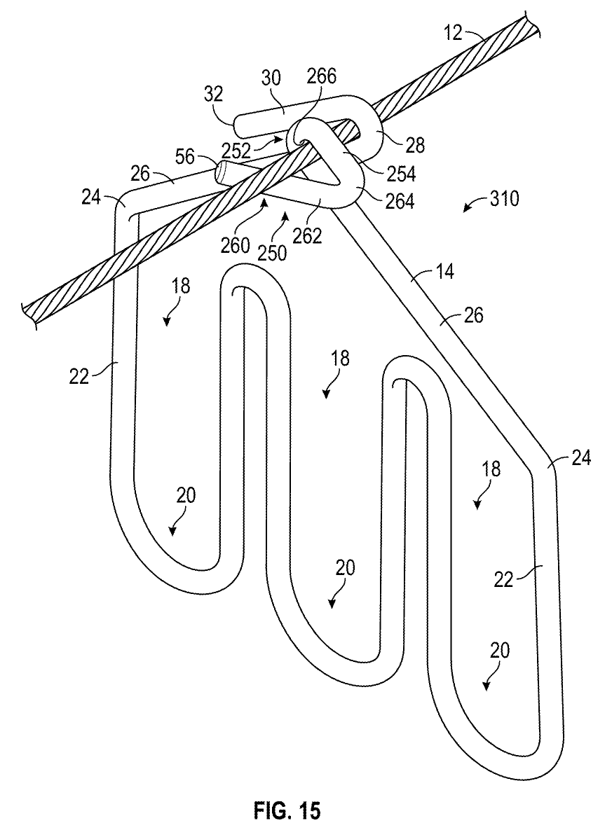

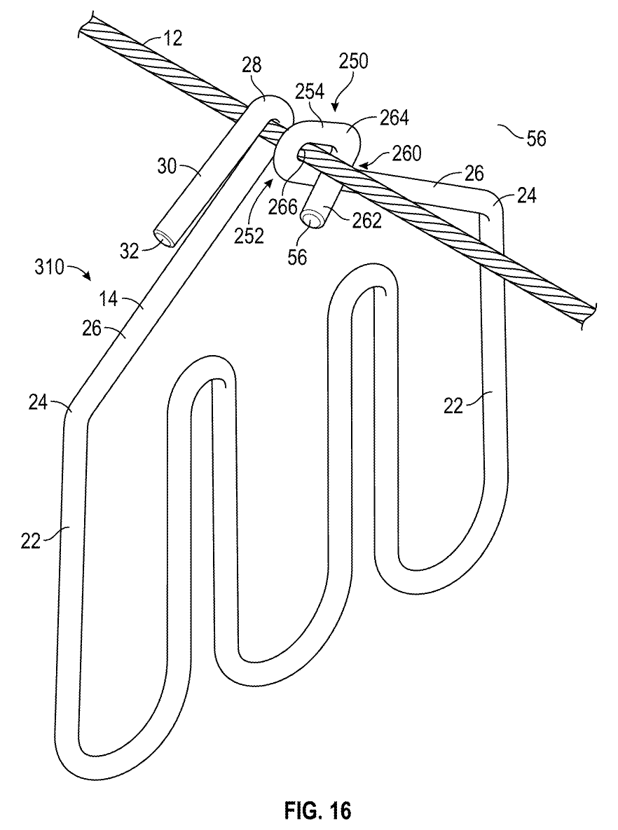

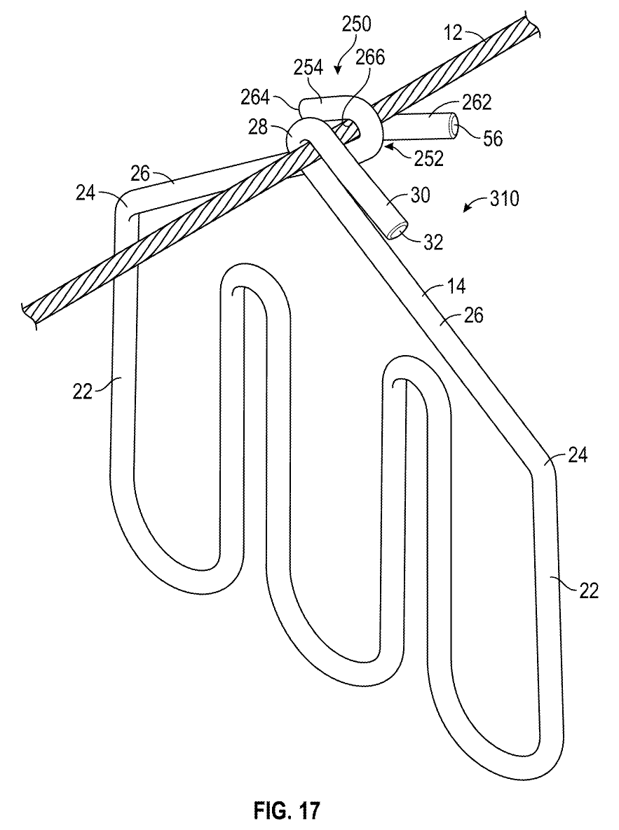

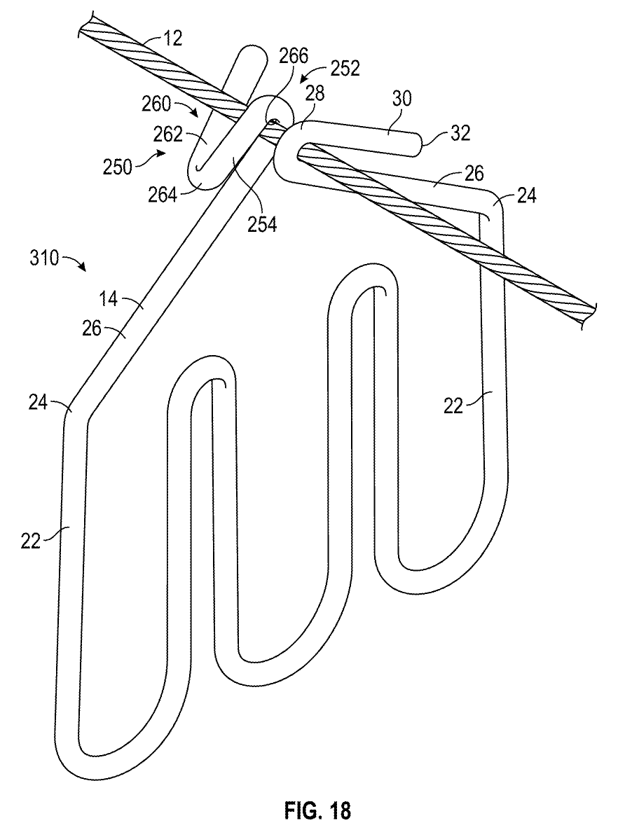

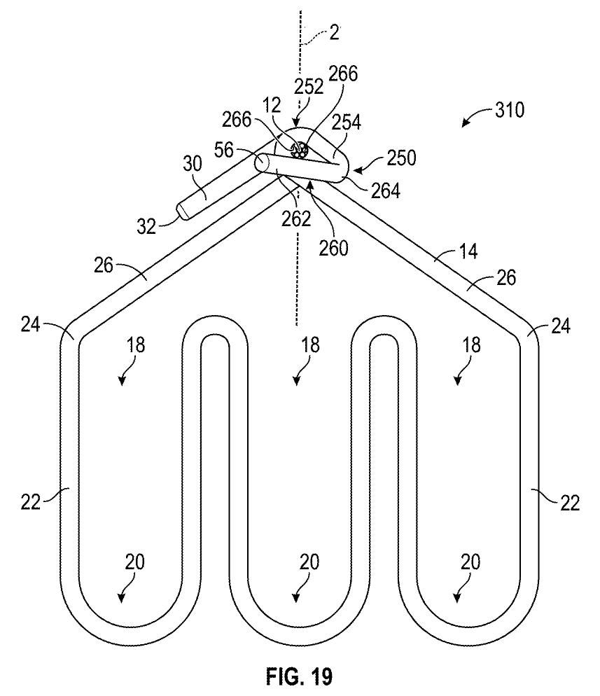

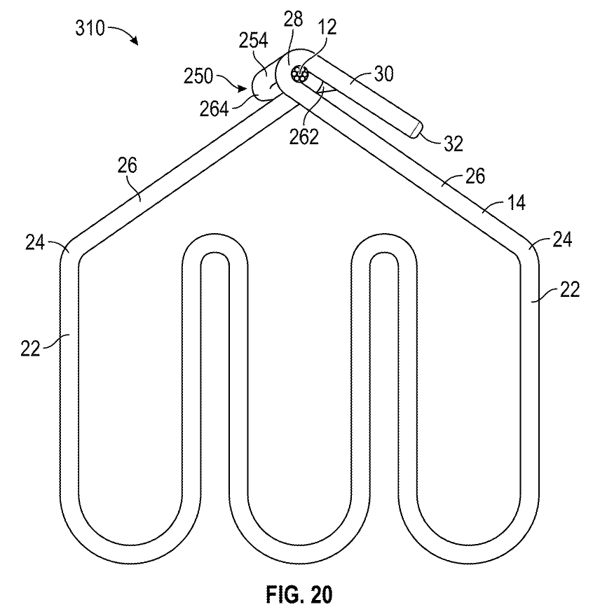

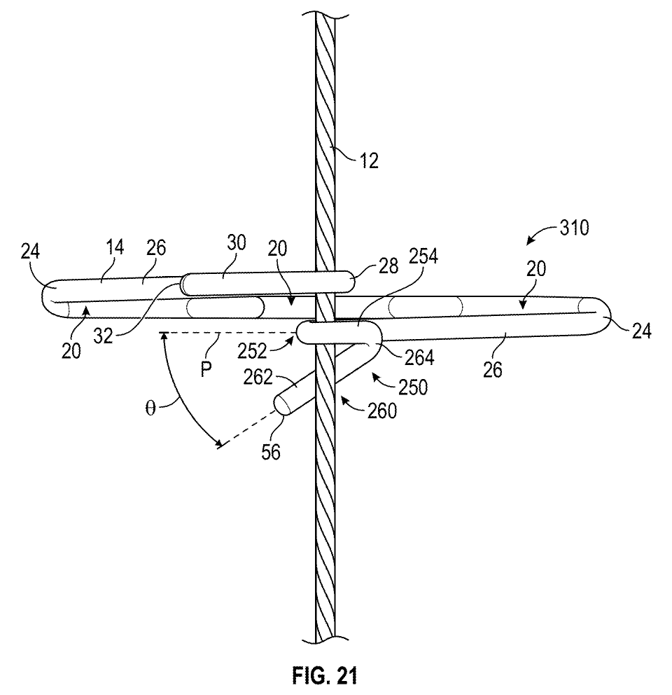

Further example cable hangers 210, 310 of similar construction as hangers 10 and 110 but having a retention arrangement 250 in accordance with yet another example embodiment of the disclosed concept, are shown in FIGS. 9-14, and FIGS. 15-21 respectively, along with an example portion of the messenger wire 12. In such examples, the retention arrangement 250 includes a hook 252 disposed generally perpendicular to the messenger wire 12. In an example embodiment the hook 252 is formed by bending a third portion 254 of the wire 14 (that is spaced from the second tip 56) outward from a central vertical axis 2 (FIG. 19) of the hanger 210, 310 and above the adjacent support arm 26 (e.g., see the top views of FIGS. 14 and 21) about 180 degrees with respect to the adjacent support arm 26 such that the third portion 254 is almost parallel to the adjacent support arm 26. In some examples, the hook 252 is sized so as to fit snugly with the messenger wire 12 when engaged therewith. The retention arrangement 250 further includes a locking portion 260 extending from the third portion 254. In an example embodiment the locking portion 260 is formed by bending the tip 56 of the wire 14 along with a fourth portion 262 thereof that is adjacent the tip 56 and the third portion 254, generally back toward the center vertical axis 2 of the hanger 210, 310 and slightly outward from a reference plane P (FIGS. 14 and 21) in which generally the remainder of the hanger 210, 310 lies. Accordingly, the third portion 254 and the fourth portion 262 are separated by a bend 264. In an example embodiment, such bending is carried out such that the fourth portion 262 is generally horizontal (e.g., generally parallel to the bottom of the hanger 210) and extends outward from the reference plane P, in which the rest of the hanger 210, 310 is generally positioned, at an angle ɵ (FIGS. 14 and 21). In some example embodiments, the fourth portion 262 is angled slightly with respect to the horizontal (e.g., a plane perpendicular to the central vertical axis 2). Such angle is in the range of from about -10 to +10 degrees (i.e., below of above the horizontal). In some example embodiments of the disclosed concept the angle ɵ is in the range of 30-35 degrees, however, it is to be appreciated that other angles may be employed without varying from the scope of the disclosed concept. An eye 266 is defined by the hook 252. In example embodiments the eye 266 (accounting for the coating 16 in some examples) is sized so as to fit snugly around a support wire (e.g., messenger wire 12). The locking portion 260 requires the hanger 210, 310 to be turned at least 55-60 degrees (i.e., 90 – ɵ) generally about its central vertical axis 2 so as to orient the fourth portion 262 generally parallel to the messenger wire 12 and thus allow for the messenger wire 12 to be guided into the eye 266, or conversely for the messenger wire 12 to be removed from the eye 266 for the cable hanger 210 to be removed from the messenger wire 12. As can be readily appreciated from the top views of hangers 210, 310 of FIGS. 14 and 21, when the messenger wire 12 is positioned in the eye 266 and the hanger 210,310 is positioned perpendicular to the messenger wire 12 (as would be the case when electrical cables are supported therein/thereon), the locking portion 260 is disposed under the messenger wire 12. Accordingly, it is to be appreciated that the retention arrangement 250 thus serves to retain the messenger wire 12 generally within the eye 266 if/when the hanger 210 is engaged by an animal or other object, thus preventing the hanger 210 from becoming unwantingly dislodged from the messenger wire 12.

From the foregoing examples it is thus to be readily appreciated that the disclosed concept provides solutions for preventing the unwanted disengagement of hangers used to organize/support cabling associated with solar arrays from the support cabling on which they are installed. It is to be appreciated that retention arrangements in accordance with the disclosed concept can be readily employed with cable hangers of various design/arrangements without varying form the scope of the disclosed concept. Some examples of such variations include, without limitation, variations in the quantity, shape, spacing of receptacles for supporting power cables provided as portions of the cable hanger and/or any other structures (e.g., without limitation, data loops or other receptacles/supports provided as portions of the hanger for supporting electrical or other signal cabling) provided as portions of the cable hanger.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In any device claim enumerating several means, several of these means may be embodied by one and the same item of hardware. The word “a” or “an” preceding an element does not exclude the presence of a plurality of such elements. The mere fact that certain elements are recited in mutually different dependent claims does not indicate that these elements cannot be used in combination.

What is claimed is:

1. A cable hanger for supporting a plurality of electrical cables along a messenger wire in a solar power installation, the cable hanger comprising:
a number of cable support structures sized and configured to be disposed below the messenger wire when the cable hanger is positioned on the messenger wire; and
a retention arrangement coupled to the number of cable support structures and structured to couple the cable hanger to the messenger wire, the retention arrangement comprising:
a hook portion extending from the number of cable support structures and structured to loop back over the messenger wire in a reference plane perpendicular to the messenger wire and extend outward from a central vertical axis of the hanger to a bend; and
a locking portion extending from the bend at a first angle relative to the reference plane and a second angle relative to a plane disposed perpendicular to the central vertical axis, wherein the locking portion is structured to extend under and protrude beyond the messenger wire when the cable hanger is installed on the messenger wire.

2. The cable hanger of claim 1, wherein the first angle is in the range of about thirty to thirty five degrees.

3. The cable hanger of claim 1, wherein the second angle is in the range of about negative ten to plus ten degrees.

4. The cable hanger of claim 2, wherein the second angle is in the range of about negative ten to plus ten degrees.

5. The cable hanger of claim 1, wherein the locking portion is structured to be in engagement with the messenger wire when the hanger is installed on the messenger wire.

6. The cable hanger of claim 1, wherein the hook portion defines an eye that is structured to fit snugly around the messenger wire.

7. The cable hanger of claim 1, wherein the retention arrangement is formed from a shape retention wire.

8. The cable hanger of claim 7, wherein the shape retention wire comprises a PVC coating disposed thereon.

9. The cable hanger of claim 1, wherein the number of support structures comprises a plurality of upwardly opening cable support receptacles, each cable support receptacle structured to support at least one electrical cable of the plurality of electrical cables.

10. The cable hanger of claim 9, wherein the number of upwardly opening cable support receptacles comprises a plurality of upwardly opening receptacles.

11. The cable hanger of claim 1, wherein the number of support structures and the retention arrangement are portions of a single shape retention wire.

12. The cable hanger of claim 11, wherein the shape retention wire includes a coating disposed thereon.

13. The cable hanger of claim 12, wherein the shape retention wire is encased in the coating.

14. The cable hanger of claim 1, wherein:
the cable hanger comprises a shape retention wire;
the number of support structures comprises a plurality of upwardly opening receptacles, each structured to receive a number of cables of the plurality of electrical cables;
each receptacle of the plurality of receptacles includes a trough area and lateral sides extending upwardly from the trough area;
at a top of the outer lateral side of each of the outermost receptacles is a bend that joins the lateral side with a support arm that extends toward a central vertical axis of the cable hanger;
the hook portion of the retention arrangement is disposed at an end of the support arm; and
the plurality of receptacles, the bend at the top of the outer lateral side of each of the outermost receptacles and the support arm that extends toward the central vertical axis, and the retention arrangement are each portions of the shape retention wire.

15. The cable hanger of claim 14, wherein the shape retention wire is encased in a coating.
